(19) United States
(12) Patent Application Publication
(10) Pub. No.: US 2015/0081404 A1
(43) Pub. Date: Mar. 19, 2015

(54) DRIVER BEHAVIOR ENHANCEMENT USING SCORING, RECOGNITION AND REDEEMABLE REWARDS

(71) Applicant: Intelligent Mechatronic Systems Inc., Waterloo (CA)

(72) Inventor: Otman A. Basir, Waterloo (CA)

(21) Appl. No.: 14/458,240

(22) Filed: Aug. 12, 2014

Related U.S. Application Data
(60) Provisional application No. 61/864,686, filed on Aug. 12, 2013.

(51) Int. Cl. G06Q 30/02; G06Q 50/00; G06Q 30/08

(52) U.S. Cl. CPC G06Q 30/0207; G06Q 30/08; G06Q 50/01
USPC 705/14.1; 705/26.3

(57) ABSTRACT

A method for improving the driving behavior of a driver includes the step of receiving a request to establish a goal from a first user, such as a parent. A request to establish a non-monetary reward from the first user is received. The driving behavior of a second user, such as a teen, is monitored over time. The driving behavior of the second user is compared to the goal. Based upon the comparison, is may be indicated that the second user has met the goal and can receive the non-monetary reward.

### BACKGROUND

Driver behavior monitoring systems are becoming well-known. With fairly inexpensive additional hardware, the driving behavior of an insured customer or teen child can be monitored. This may be done for the purpose of calculating an insurance premium and/or for the purpose of ensuring the safe driving habits of the young driver.

Rewards for safe driving behavior can improve the driving behavior of both adults and teens. Since the driving behavior may already be monitored for some other purpose, this monitored behavior can easily provide the basis for a better system for rewarding safe and/or efficient driving behavior.

### SUMMARY

Important events are derived from vehicular behavior. The present system and method concern the application of control theory principles to develop effective means to influence driving behavior for the purpose of safety, and environmental friendliness. Ideas from gaming are used to make safety and environmental friendliness an interactive game with actionable moves and valuable rewards and tokens of recognition. This system and method will allow fleet owners to interact with its fleet drivers in a process of coaching and reward and recognition to achieve effective behavior influencing to improve fleet safety, vehicle maintainability and health, productivity, driver satisfaction, customer satisfaction, and demonstrate social responsibility in terms of safety and greenness. Rental car companies can use the system to engage with their clients to help them achieve better use of the fleet vehicles in terms of safety and responsible usage. For example, a car rental client will be incentivized to drive the rental car carefully and safely so that he/she will accumulate more rewards that can be redeemed in various forms, including credit toward future rental. This will also provide for stronger relationship between the car rental service provider and the client. The system and method can be used by insurance companies and automotive clubs companies to interact with their policy holders and members in a rewarding process that will lead to enhanced driving behavior of the policy holder or member.

A method for improving the driving behavior of a driver includes the step of receiving a request to establish a goal from a first user, such as a parent. A request to establish a non-monetary reward from the first user is received. The driving behavior of a second user, such as a teen, is monitored over time. The driving behavior of the second user is compared to the goal. Based upon the comparison, is may be indicated that the second user has met the goal and can receive the non-monetary reward.

The second user may be able to choose whether to redeem the non-monetary reward after it is awarded. A number of credits may be awarded based upon the comparison and the credits may accumulate over time. The second user can then choose when to redeem the accumulated credits in order to receive the reward.

Further, the location of the driver (e.g. via the location of the driver's vehicle) may be determined. Based upon the driver's location, the system may provide a suggestion to the driver regarding how to redeem a reward. For example, the system may suggest to the driver that the driver can redeem an award at a nearby restaurant, store, etc.

The reward can be associated with a specific vehicle, such that the location of the vehicle can be used to view an account balance and to redeem awards in exchange for services or goods.

The system may also provide competitive approaches that allow the driver to bid to outperform other drivers or participants in the reward or driver scoring program. This approach encourages the participants to challenge themselves, and provides additional incentives when they succeed with their own challenges/bids. The driver can participate in a competition with other members of his/her social network or other members who are participants of the reward and/or driver-scoring program. The driver can bid to achieve a certain driving score. The system in this case will compute driving tips to help the driver achieve such goal. The driver can bid to outperform other drivers and the winner will be granted more awards.

### BRIEF DESCRIPTION OF THE DRAWINGS

FIG. 1 is a schematic of hardware that can be used to implement the system and method of the present invention.

FIG. 2 is a flowchart showing one possible implementation.

FIG. 3 is a sample user interface that could be used in connection with the flowchart of FIG. 2.

### DETAILED DESCRIPTION

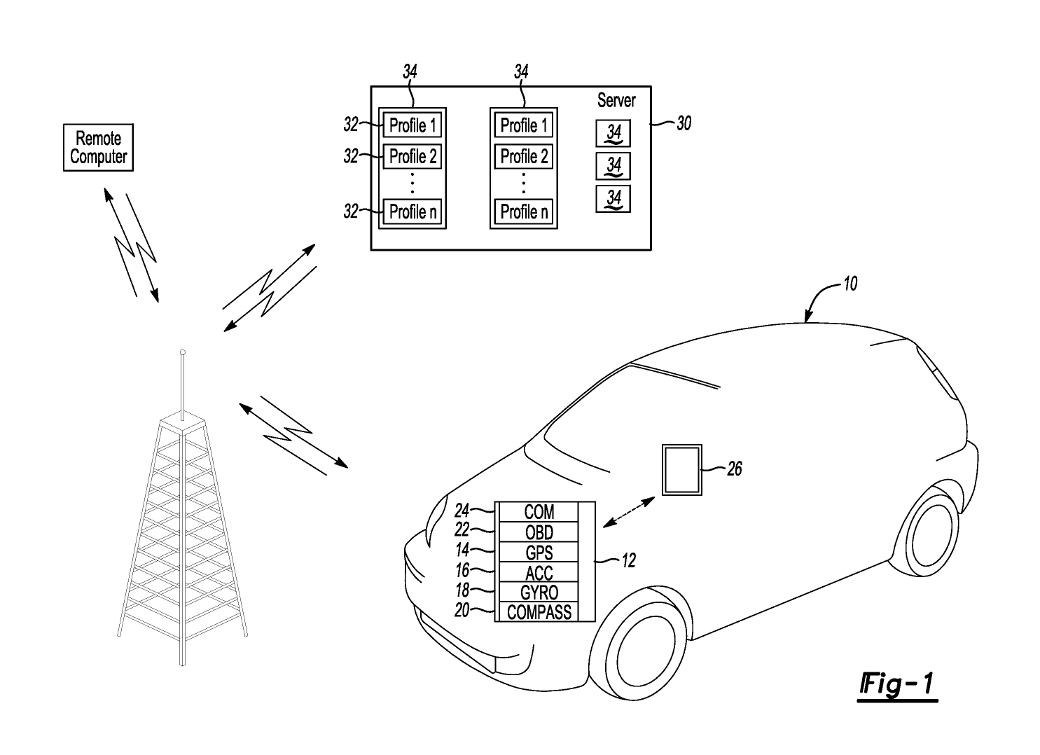

Referring to FIG. 1, a motor vehicle 10 includes a plurality of data gathering devices that communicate information to an appliance 12 installed within the vehicle 10. The example data gathering devices include a global positioning satellite (GPS) receiver 14, a three-axis accelerometer 16, a gyroscope 18 and an electronic compass 20, which could be housed within the appliance 12 (along with a processor and suitable electronic storage, etc. and suitably programmed to perform the functions described herein). As appreciated, other data monitoring systems could be utilized within the contemplation of this invention. Data may also be collected from an onboard diagnostic port (OBD) 22 that provides data indicative of vehicle engine operating parameters such as vehicle speed, engine speed, temperature, fuel consumption (or electricity consumption), engine idle time, car diagnostics (from OBD) and other information that is related to mechanical operation of the vehicle. Moreover, any other data that is available to the vehicle could also be communicated to the appliance 12 for gathering and compilation of the operation summaries of interest in categorizing the overall operation of the vehicle. Not all of the sensors mentioned here are necessary, however, as they are only listed as examples.

The appliance 12 may also include a communication module 24 (such as cell phone, satellite, wi-fi, etc.) that provides a connection to a wide-area network (such as the internet). Alternatively, the communication module 24 may connect to a wide-area network (such as the internet) via a user's cell phone 26 or other device providing communication.

The in vehicle appliance 12 gathers data from the various sensors mounted within the vehicle 10 and stores that data. The in vehicle appliance 12 transmits this data (or summaries or analyses thereof) as a transmission signal through a wireless network to a server 30 (also having at least one processor and suitable electronic storage and suitably programmed to perform the functions described herein). The server 30 utilizes the received data to categorize vehicle operating conditions in order to determine or track vehicle use. This data can be utilized for tracking and determining driver behavior, insurance premiums for the motor vehicle, tracking data utilized to determine proper operation of the vehicle and other information that may provide value such as alerting a maintenance depot or service center when a specific vehicle is in need of such maintenance. Driving events and driver behavior are recorded by the server 30, such as fuel and/or electricity consumption, speed, driver behavior (acceleration, speed, etc.), distance driven and/or time spent in certain insurance-risk coded geographic areas. For example, the on-board appliance 12 may record the amount of time or distance in high-risk areas or low-risk areas, or high-risk vs. low risk roads. The on-board appliance 12 may collect and transmit to the server 30 (among other things mentioned herein): Speed, Acceleration, Distance, Fuel consumption, Engine Idle time, Car diagnostics, Location of vehicle, Engine emissions, etc.

The server 30 includes a plurality of profiles 32, each associated with a vehicle 10 (or alternatively, with a user). Among other things, the profiles 32 each contain information about the vehicle 10 (or user) including some or all of the gathered data (or summaries thereof). Some or all of the data (or summaries thereof) may be accessible to the user via a computer 32 over a wide area network (such as the internet) via a policyholder portal, such as fuel efficiency, environmental issues, location, maintenance, etc. The user can also customize some aspects of the profile 32.

It should be noted that the server 30 may be numerous physical and/or virtual servers at multiple locations. The server 30 may collect data from appliances 12 from many different vehicles 10 associated with a many different insurance companies. Each insurance company (or other administrator) may configure parameters only for their own users. The server 30 permits the administrator of each insurance company to access only data for their policyholders. The server 30 permits each policyholder to access only his own profile and receive information based upon only his own profile.

The server 30 may not only reside in traditional physical or virtual servers, but may also coexist with the on-board appliance, or may reside within a mobile device. In scenarios where the server 30 is distributed, all or a subset of relevant information may be synchronized between trusted nodes for the purposes of aggregate statistics, trends, and geo-spatial references (proximity to key locations, groups of drivers with similar driving routes).

Independent of the particular underlying hardware, events and driving behavior are derived. The present system and method concern the application of control theory principles to develop effective means to influence driving behavior for the purpose of safety, and environmental friendliness. Ideas from gaming are used to make safety and environmental friendliness an interactive game with actionable moves and valuable rewards and tokens of recognition. This system and method will allow fleet owners to interact with its fleet drivers in a process of coaching and reward and recognition to achieve effective behavior influencing to improve fleet safety, vehicle maintainability and health, productivity, driver satisfaction, customer satisfaction, and demonstrate social responsibility in terms of safety and greenness. Rental car companies can use the system to engage with their clients to help them achieve better use of the fleet vehicles in terms of safety and responsible usage. For example, a car rental client will be incentivized to drive the rental car carefully and safely so that he/she will accumulate more rewards that can be redeemed in various forms, including credit toward future rental. This will also provide for stronger relationship between the car rental service provider and the client. The system and method can be used by insurance companies and automotive clubs companies to interact with their policy holders and members in a rewarding process that will lead to enhanced driving behavior of the policy holder or member.

Rewards and Recognition—Definitions

As the terms implies rewards and recognition are strategies that are employed to enhance performance and strengthen engagement or participation in a program. The following are definitions of these terms.

Rewards—cash, near cash, or other items given to a person, team, or organization for the achievement of a combination of objective(s) and goal(s).

Recognition—this is a formal or informal acknowledgement of appreciation presented in the form of a verbal and/or written response and/or coupled with a reward.

Rewards and recognition programs can have direct costs associated with them in that an individual or an organization is compensated in cash or near cash award such as stock options, gift cards, discount, coupon etc.

While cash has generally universal appeal there are some limitations to its effectiveness because it is more of a rational than an emotional transaction. Receiving cash for performance is more of compensation than a reward. Consequently non cash awards are growing in importance and especially those that link to brand objectives, goals, strategies, measures (OGSM) as well as Vision, Mission and Values.

Non-cash rewards can help build more emotional connections with brands and hence are growing in popularity.

Further, “one size does not fit all” so there is also a trend for personalized rewards and recognition to satisfy individual preferences. In such cases, rewards are often linked to menus or catalogues, where an individual can trade points or select from a range of rewards and recognition programs.

Rewards and Recognition programs generally are built to reinforce an existing brand platform, or in the case of an individual, based on a family's values and rules. For example, if a brand stands for innovation then the Rewards and Recognition would enhance “innovation” for the program to be seen “on brand.”

Similarly in a parent-teen environment, the Reward and recognition program should build on family norms such as providing a weekly allowance (or not) or punishments, such as restricting access to the family vehicle(s). One individual (i.e. a parent) can establish a non-monetary reward (i.e. access to the family car as a reward for good driving), or a tangible reward (i.e. an Xbox), and the participant can choose to reimburse their earned credits for this non-monetary reward. In traditional Gamification solutions, the reward is presented to the participant based on a score. In this approach, the score earns the participant credits. The participant can make their own choice how to convert these credits into one or more rewards of their choosing.

Rewards and Recognition—Satisfying Consumer Needs

While there are a number of resources one can reference to find rewards and recognition, it is best to start with the needs of the end user before constructing a program. That way the rewards and recognition will most likely be of direct value to the individual.

Some of these can be determined by satisfying a hierarchy of needs, and in the case of vehicle telematics:

1. Safe driving, e.g. alerts, driver coaching, detection systems.

2. Driving related information, e.g. connectivity, traffic, weather, maps.

3. Driving assistance, e.g. communication, navigation, parking assist.

4. Entertainment, e.g. music, eBooks, video/games (rear seat).

5. Belonging, e.g. personalization, social media, tribes.

“Physical rewards and recognition” includes merchandise, value added services (e.g., infotainment on the go) and experiences (e.g., access to “restricted events”).

“Virtual rewards and recognition” includes points (that can be redeemed for physical rewards) virtual goods, badges, status, peer recognition.

Gamification

Gamification is the use of game thinking and game mechanics in a non-game or near-game context in order to better engage companies or end-users and to solve problems. In this age, when there are increasing distractions, it is difficult for a brand to retain the focus of its consumers. One way to get them to literally spend more time with the brand (i.e., engage with the brand) is through gamification techniques that capture interest, involve individuals in an activity related to the brand and build off an individual's desire to perform, compete, and win either in a team or as an individual.

The typical rewards for gamification include the collection of points, achievement of levels, and/or collection of virtual currency, badges or status e.g., becoming the virtual Mayor of a particular geography. As such, gamification is another method to reward and recognize an individual.

Recognition Programs

The following lists present some of the Rewards, Recognition and Gamification programs both for internal programs (which an insurance company wants to run a company or ecosystem program) and external programs (when this involves end-users such as policyholders, young drivers, mature drivers, drivers of fleet vehicles or those using tolled roads):

Internal Incentives for the Insurance Carrier (using an Insurance Carrier as the Example)

| | Goal | | |
|---|---|---|---|
| Objective | Audience | Reward | Rationale |
| Generate buzz | All | Group travel or | Travel & merchandise |
| | employees/Channel | Valuable | generate more |
| | Partners | merchandise | discussion than cash |
| Team bonding | Sales | Group incentive | Allows exchange of |
| | employees/Channel | travel | ideas/build working |
| | partners (brokers) | | relationships |
| Build trust with high | Employees or channel | Luxury offsite | Setting away to |
| performers & senior | partners | conference | stimulate new |
| management | | | thinking/sharing/trust |
| | | | building |
| Drive Sales | Sales people/Channel | Thoughtful non- | Best for clear goals. |
| | partners | cash rewards e.g., | Assumes competitive |
| | | giftcards | compensation |

External

| | Goal | | |
|---|---|---|---|
| Objective | Target | Reward | Rationale |
| Reinforce positive | All drivers | Spot merchandise | Acts as regular |
| behavior | | (frequent & small | reminder |
| | | value rewards) | Recognition is its |
| | | Praise/feedback | own reward |
| Instill positive | All drivers | Individual/family | Select from a menu |
| memories | | travel | based on |
| | | | individual's |
| | | | preference |
| Engage influencers | All | Thoughtful | Brands should |
| (Parents, teachers) | | merchandise | include influencers |
| Drive Participation | All | Aligned merchandise | Reinforce brand |
| | | | message e.g., |
| | | | smartness |
| Loyalty | Employees/Channel | Carefully selected | Demonstrates the |
| | partners/End users | rewards delivered at | brand's |
| | | key targets | commitment |

In-vehicle System 12 (FIG. 1—hardware and software—such as a DriveSync® system) to provide the following Data from vehicle:

1. Motion parameters: cornering, braking, speed, acceleration, land changing, idling, seatbelt use, time of driving, location of driving, day of driving, date of driving, in-vehicle alcohol level, distance driven, vehicle diagnostics.

2. Data from other sources: traffic, weather, posted speed limits, average speed on location and along route, location of intersections, stop signs, road classes.

3. Data on driver: age, gender, class of license, # of years since driver obtained driver license, driving history: including total number of hours driven and total distance driven, distance and time since trip start.

4. Best (and average) driver characteristics in age group, best (and average) driver characteristics in license class group, best (and average) driver characteristics in social network group (e.g., Facebook group, twitter group), etc.

5. Information on vehicle maintenance record.

The above information is analyzed on board the in-vehicle system 12 or at the backend system (remote server(s) 30) which is able to receive the data from in-vehicle systems 12 transmitted wirelessly (for example) to the backend system. The backend system analyzes the information listed above to produce driving scores with respect to the following aspects: harsh braking score, idling score, cornering score, tailgating score, aggressiveness score, lane switching score, sobriety score, productivity score, and overall driving score with respect to safety, greenness, and productivity. All scores are presentable on trip basis, daily basis, weekly basis, monthly basis and yearly basis. The scores are also presented as trends to allow the driver (or fleet owner, parent, driving coach). A model is used to process the data in 1 to 5 above to produce these scores. The model uses linguistic engine (fuzzy engine) to map these data to compute scores. This allows for employing expert knowledge to judge the driver with respect to all driving scores above. A probabilistic model is used to determine each driving score based on a priori knowledge and training samples that represent a spectrum of driver profiles. A Dempster shafer evidence model is used to produce similar scores. A scoring fusion is used to combine the scoring information produced by the fuzzy, and probabilistic and Dempster shafer models to compute reliable scoring data.

To reinforce good driving behavior a model is used to map these scoring data to tangible rewards or points that allow the driver or driver designated person to convert these points/awards to goods or services, including but not limited to: Starbucks coffee, McDonald meals, airmiles, insurance discounts, music, books, oil change, down payment towards buying a car, and gas. Driving behavior is also recognized by badges, trophies, etc. The model is developed so that it encourages safer and/or green driving. The safer the driver is the more rewards the driver gets, the greener the driver is the more rewards the driver gets. The model also balances distance driving with award allocation to prevent usage of long distance driving from being used as means to accumulate awards. That is, a balance is struck between quantity of driving and quality of driving. The driver can gift his/her awards to members of his social network or relatives. The driver can choose in what product or service the awards can be redeemed.

A model is employed by the system to provide realtime coaching tips to the driver during driving, just before trip starting and/or at the end of the trip. These coaching tips help the driver improve his/her safety or green scoring and as a result will maximize his/her redeemable awards.

Based on the driver award account status and the driver vicinity to the location of a place where awards can be redeemed (e.g. Starbucks), the system will provide in-vehicle suggestions to redeem the awards.

The user can associate his awards account to a vehicle identification number. When the car drives in the vicinity of a place where awards can be redeemed, the yin of the car is used by the redeeming party to view account balance and redeem awards in exchange of services or goods delivered to the driver of the vehicle.

The driver can participate in a competition with other members of his/her social network or other members who are participants of the reward and/or driver scoring program. The driver can bid to achieve a certain driving score. The system in this case will compute driving tips to help the driver achieve such goal. The driver can bid to outperform other drivers and the winner will be granted more awards.

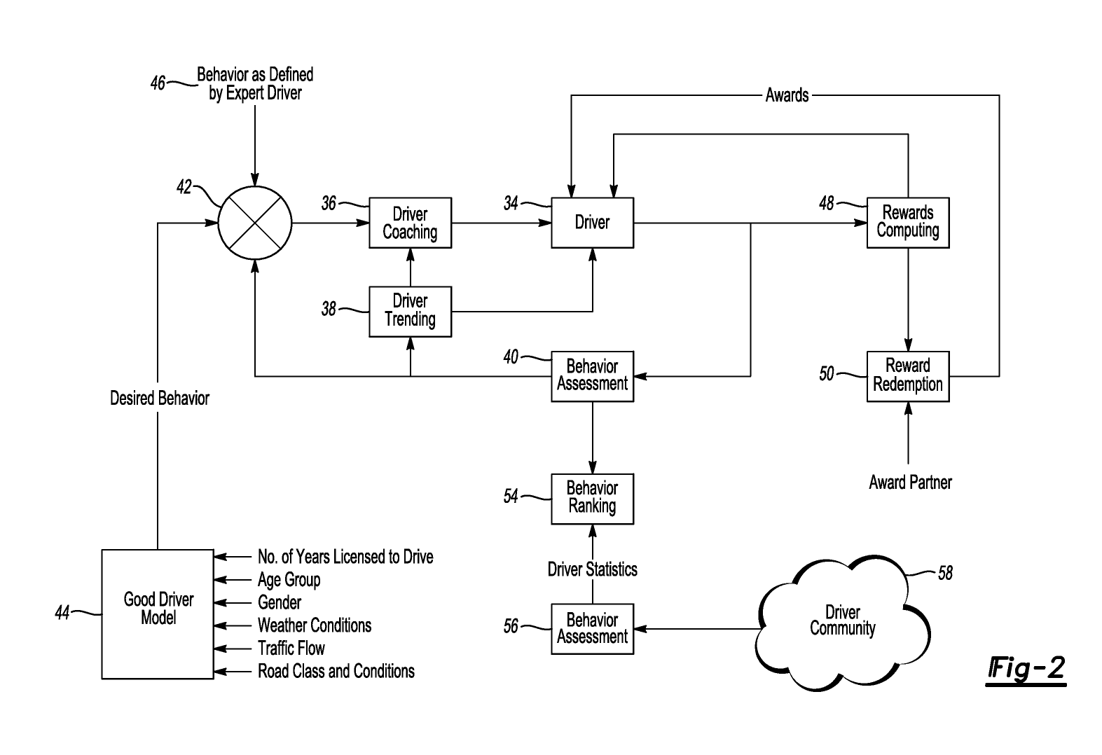

FIG. 2 shows an example flowchart that could be used to implement the methods described above. The driver 34 receives coaching tips 36 and information regarding trends 38 in the driver's behavior. The driver's behavior, as evaluated by the system 10 (FIG. 1), is used in rewards computing 48 which in turn leads to reward redemption 50. The driver's behavior as evaluated in the behavior assessment 40 is used in behavior ranking 54 where it is ranked against the behavior assessment 56 of other drivers in the community 58 (e.g. peer groups, social media connections, friends, etc). A good driver model 44 receives information regarding this particular driver (e.g. in light of experience, age group, gender, etc) and current conditions such as weather, traffic and road class and conditions and generates a desired driving behavior which is evaluated with behavior as defined by an expert driver 46 and the driver's behavior assessment 40 in step 42 to generate the driver coaching 36 (e.g. tips and suggestions offered to the driver).

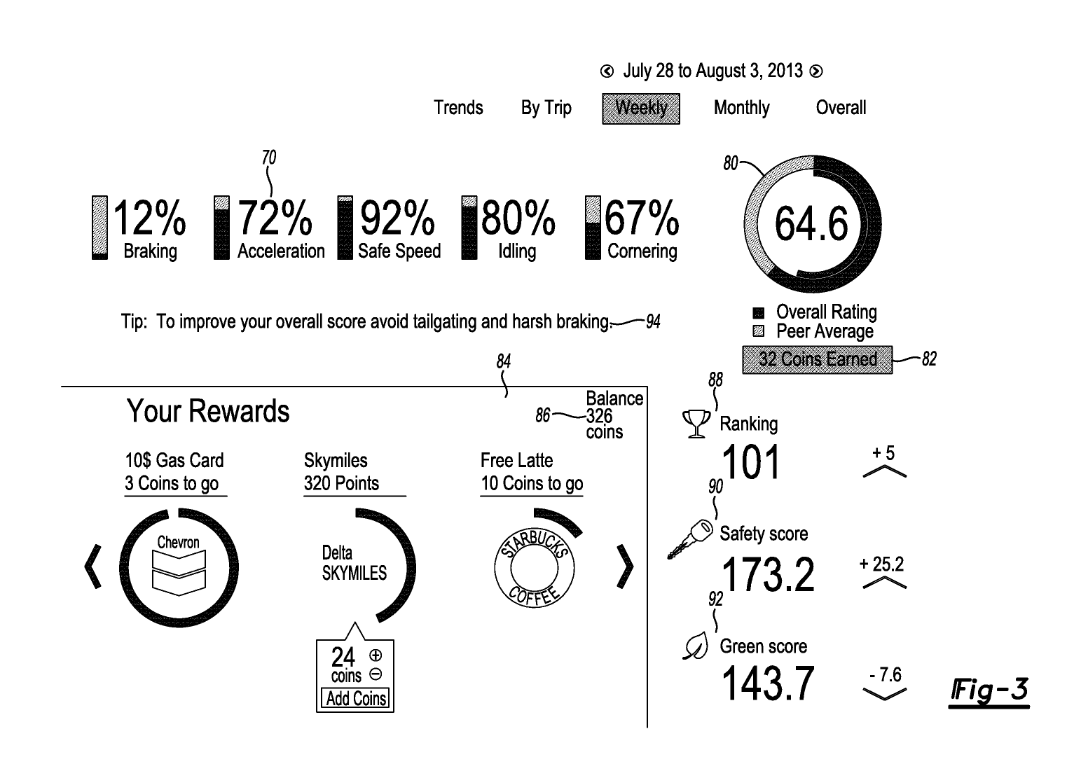

FIG. 3 shows a user interface that could be provided to the user to access his profile 34 (FIG. 1) such as by a remote computer, smartphone, tablet, etc. The user interface provides feedback and status regarding the user's driving behavior and rewards. For example, the user interface may provide scores 70 regarding specific driving behavior such as braking, acceleration, safe speed, idling and cornering. An overall score 80 and graph is provided and also gives a comparison to the user's peer average. The user interface indicates the level of points accumulated 82, such as “coins.” The user interface also indicates progress 84 as to how close the user is to being able to redeem the points or coins for specific rewards (such as a gas card, frequent flier miles and beverages or food). The balance 86 of coins is provided. The user interface may also indicate a ranking 88 relative to other drivers, such as peers or those in a similar demographic. The user interface also provides a safety score 90 based upon the user's driving behavior. A green score 92 may also be provided based upon the user's driving behavior (a higher score indicating environmentally friendly driving behavior, such as reasonable braking, acceleration and idling times).

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A method for improving the driving behavior of a driver including the steps of:
a) receiving a request to establish a goal from a first user;
b) receiving a request to establish a non-monetary reward from the first user;
c) monitoring the driving behavior of a second user over time;
d) comparing the driving behavior of the second user to the goal;
e) based upon the comparison in said step d), indicating that the second user has met the goal and can receive the non-monetary reward.

2. The method of claim 1 wherein the second user can choose whether to redeem the non-monetary reward after said step e).

3. The method of claim 1 including the steps of awarding a number of credits based upon the comparison in said step d) and accumulating the number of credits over time.

4. The method of claim 3 further including the step of receiving a request from the second user to redeem the accumulated credits in order to receive the reward.

5. A method for improving the driving behavior of a driver including the steps of:
a) monitoring the driving behavior of the driver over time;
b) determining a location of the driver; and
c) based upon the behavior monitored in said step a) and the location determined in said step b), providing a suggestion to the driver regarding how to redeem a reward.

6. The method of claim 5 further including the step of associating the reward with a specific vehicle.

7. The method of claim 6 further including the steps of:
d) identifying that the driver is in the specific vehicle;
e) receiving a reward balance request from the driver; and
f) determining whether to indicate the reward balance based upon said steps d) and e).

8. A method for improving the driving behavior of a first driver including the steps of:
a) receiving a bid from the first driver;
b) communicating the bid to a plurality of other drivers;
c) monitoring the driving behavior of the first driver and the other drivers over time;
d) comparing the driving behaviors to the bid;
e) based upon the comparison in said step d), indicating that at least one of the first driver and the other drivers has met or exceeded the bid.

9. The method of claim 8 wherein the other drivers are members of a social network with the first driver.
